(19) United States
(12) Patent Application Publication
(10) Pub. No.: US 2018/0004711 A1
(43) Pub. Date: Jan. 4, 2018

(54) METHOD AND SYSTEM FOR AUTOMATICALLY GENERATING DOCUMENTS ON THE BASIS OF AN INDEX

(71) Applicant: VALIPAT S.A., Brussels (BE)

(72) Inventor: Olivier Gerardin, Uccle (BE)

(73) Assignee: VALIPAT S.A., Brussels (BE)

(21) Appl. No.: 15/545,023

(22) PCT Filed: Feb. 5, 2016
(86) PCT No.: PCT/EP2016/052475

§ 371 Date: Jul. 20, 2017

(30) Foreign Application Priority Data
Feb. 13, 2015 (BE) 2015/5080

(51) Int. Cl. G06F 17/21; G06F 17/24; G06F 17/30; G06F 17/22; G06Q 50/18

(52) U.S. Cl. CPC G06F 17/212; G06F 17/30011; G06F 17/2205; G06F 17/243; G06Q 50/18

(57) ABSTRACT

A system and method for automatically generating at least one document, in particular of procuration type intended for authorizing an agent to carry out an action on behalf of a client, the method includes: a step of selecting values of a first parameter and of a second parameter in such a way as to form a generation context; a step of consulting the static index so as to obtain the virtual document or the pre-finalized document in the PDF format associated with said generation context; in the case of a virtual document, a step of requesting from a database the page layout and the paragraphs pointed at by the virtual document obtained; and a step of generating said document in an electronic format, containing the paragraphs returned by said request and the page layout returned by said request.

### FIELD OF ART

This invention relates to the field of automatic document generation. The invention in particular has an application in the automatic generation of documents such as powers of attorney or powers which are intended to authorise a proxy to perform an action on behalf of a principal.

### BACKGROUND

In many situations, an individual or an entity cannot execute a certain action themselves, for practical reasons (distance, lack of time) and/or legal reasons (not authorised to execute this action themselves). This individual or entity must therefore have this action executed by another individual or entity, on their behalf.

By way of example, mention can be made of the power that allows a lawyer or a law firm to represent an individual or entity before a national or regional jurisdiction in order to accomplish their legal and and/or administrative acts.

The management of such powers can be involved and complicated administratively. This is the case in particular in the common situation wherein the individual or entity that wants to carry out an action before several jurisdictions, contacts their usual lawyer who himself is not authorised to execute said action in all of the jurisdictions involved.

In such a case, the lawyer makes use of a network of lawyers authorised to represent his client before the various jurisdictions involved, and must take care of having his client sign a different power for each jurisdiction with which the action has to be executed. This problem arises in particular for carrying out acts (filing, withdrawal, etc.) concerning applications for patents, marks or drawings and models.

In such a case, the lawyer has to contact the authorised individuals or entities one by one, receive one by one the power forms that he must forward to his client for signature (who is giving the power), then send them back to the various lawyers in his network for execution of the action with the various jurisdictions.

In order to simplify this management, systems and methods are known which are based on collecting powers which are scanned and stored in a database.

The management of such a database of powers is complex in that it has to contain a document for each situation that can arise.

As such, the database has to include a general power with regards to the filing of a patent application in Europe in the French language as well as a specific power with regards to the withdrawal of a brand in Italy and in the Italian language.

Such systems and methods give rise to problems concerning maintenance, effectiveness in information storage and retrieval, and usage. In particular, with such systems and methods, a modification made to a document requires scanning said document again, which is a disadvantage.

In addition, when a modification applies to a group of documents, for example during a change in legislation in a particular jurisdiction, it is necessary to apply changes to each document involved, which is meticulous and/or a source of error.

Conventionally, the document to be generated comprises a determined number of paragraphs of which the content is determined. It is known in prior art automatic methods for generating documents from a database of paragraphs. According to these methods, various paragraphs can be selected and the can be associated together in order to from the document to be generated. By way of example, such a method for generating is known for assistance in drafting contracts wherein a user access an automatic interface from an internet browser and selects the clauses that he wants to add to the contract to be generated. During the generation of the contract, the paragraphs regarding the selected clauses are automatically integrated into a document of the PDF type.

Such a document generation method is adapted for automatically generating a single power for a given jurisdiction. However, if the user wants to obtain a power for another jurisdiction, the user must again select the adequate paragraphs, which constitutes a waste of time.

So, there is a need for automatically generating a plurality of documents from a single step of key-entry by a user while still allowing for optimum management of the database.

It is known in prior art various methods for generating documents wherein the paragraphs are mutualised in order to limit the size of the database of paragraphs as well as the maintenance thereof.

In practice, the methods for generating of prior art require substantial computing power. Furthermore, when several documents are generated simultaneously, the time for generating is substantial, which is a disadvantage for users. Furthermore, such methods for generating are not suitable for generating documents of which the paragraphs and the layout are imposed in a strict way, for example, for generating an official form of an industrial property office.

The object of the invention is therefore to provide a solution to the aforementioned problems and disadvantages, among others.

### SUMMARY

In order to eliminate at least some of these disadvantages, the invention relates to a method for the automatic generation of at least one document, in particular of the power of attorney type intended to authorise a proxy to perform an action on behalf of a principal, with the document containing a plurality of paragraphs displayed according to a layout, with said plurality of paragraphs and said layout being according to at least one first parameter and one second parameter, with the method implementing a database comprising at least:

one base of layouts;

one base of paragraphs;

one base of pre-finalised documents in PDF format comprising a fixed frame, comprising predetermined paragraphs and layout, and at least one variable field;

a list of values of said first parameter;

a list of values of said second parameter, with each combination of values of said parameters forming a generation context;

a static index that associates each generation context with a virtual document or with a pre-finalised document in PDF format of the base of pre-finalised documents, with a virtual document comprising at least one pointer aiming for a determined layout of the base of layouts and a plurality of pointers aiming for determined paragraphs from the base of paragraphs; with the method comprising:

a step of selecting values of the first parameter and of the second parameter so as to form a generation context;

a step of consulting the static index from said generation context so as to obtain the virtual document or the pre-finalised document in PDF format associated with said generation context;

in the case of a virtual document, a step (E3) for making a request in the database (3) for layout (LY) and paragraphs (PA) pointed to by the virtual document (DOCv) obtained and a step (E4) for generating said document (DOC) in an electronic format, containing the paragraphs (PA) returned by said request and the layout (LY) returned by said request;

in the case of a pre-finalised document in PDF format (DOC_{PDF}), a step of key-entry into a data entry form, or a step of retrieving in another database, of the value of the variable field of said pre-finalised document in PDF format (DOC_{PDF}) and a step (E4′) of generating said finalised document in an electronic format.

Advantageously, thanks to the invention, the content and the values as such of the elements of the document to be generated (layouts, paragraphs) are dissociated from the association logic of said elements (virtual document). Such a dissociation makes it possible to provide great flexibility for generating documents. In addition, the method makes it possible to generate, either documents of which the format and the content (layout and paragraphs) are freely defined via a request in the corresponding bases, or documents for which the frame is fixed (frame for example imposed by industrial property offices). Advantageously, a user can simultaneously generate documents of different natures.

Furthermore, in the case of a virtual document, the step of requesting is fast to implement given that each generation context is associated with a virtual document that comprises the definition of all of the elements of the document (layout and paragraphs). In other words, thanks to the virtual documents and to the static index, the content of a document to be generated is determined directly from the generation context. Such a method for generating limits the waiting time of a user who obtains the desired document instantly, with the method being as such more effective since it requires less computing resources than the methods of prior art.

Such a method is particularly advantageous for generating a large number of documents simultaneously, in particular, powers for a plurality of jurisdictions.

The static index makes it possible to associate a generation context with a pre-finalised document in PDF format directly, with the document PDF being stored in the static index, or indirectly, with the static index comprising a pointer aiming for the pre-finalised document in PDF format of the base of pre-finalised documents in PDF format.

According to an aspect of the invention, the same paragraph of the base of paragraphs is pointed to by several different virtual documents. Similarly, the same layout is pointed to by several different virtual documents. In other words, a large number of different documents can be generated with a limited number of paragraphs and/or layouts. The mutualisation of the paragraphs and layouts facilitates maintenance. The use of a static index makes it possible, furthermore, to precisely analyse the level of mutualisation of the paragraphs and of the layouts, which facilitates maintenance as well as the creating of new documents to be generated. By way of example, if a paragraph is pointed to by only a few virtual documents, it may be interesting to check whether it can be replaced with a similar paragraph with a higher rate of mutualisation.

Advantageously, when a paragraph of the database is modified, the modification made is passed on to all of the documents generated from the virtual documents that point to said modified paragraph. In other words, a large plurality of documents to be generated is modified by modifying only one paragraph of the database, with the virtual document advantageously not being modified.

Preferably, the document comprises at least one paragraph comprising a fixed frame and at least one variable field, as such allowing for the customisation of said paragraph and/or a limitation in the number of paragraphs of the base of paragraphs.

Preferably in this case, the fixed frame of said paragraph is stored in the database with the other paragraphs.

More preferably, the method comprises a step of key-entry into a data entry form, or a step of retrieving in another database, of the value of the variable field of said paragraph.

Preferably in this case, the method comprises a step of generating a data entry form according to the generation context and a step of key-entry into the data entry form of the value of the variable field of said paragraph. As such, the data entry form and therefore the variable fields are correlated with the generation context, which facilitates and accelerates the key-entry of the variable fields.

Preferably, the step of selecting at least one parameter is done on a conditional basis according to the value of at least one other parameter. As such, the forming of combinations of values of parameters that are compatible is favoured, as impossible combinations cannot be selected, which allows the user to save time.

Preferably, several values of the same parameter are selected during the step of selecting in such a way as to form several generation contexts and as such generate several documents. Such a method as such makes it possible to generate a large number of documents simultaneously and, in particular, powers for a plurality of different jurisdictions. Such a multiple selection makes it possible to reduce the selection time of the user; indeed, in a single manipulation (i.e. a single implementation of the method according to the invention), the user can generate a group of documents of different natures. A simultaneous generation of a plurality of documents is known to those skilled in the art as a “batch”. Thanks to the index, such a generation of a plurality of different documents “by batch” is implemented rapidly.

More preferably, the method comprises a step of consulting the static index so as to obtain the virtual documents or the pre-finalised documents associated with said generation contexts and a step of generating said documents.

More preferably, the method comprises a step of consulting the static index so as to obtain the virtual documents associated with said generation contexts, a step of requesting in the database for the layout and paragraphs pointed to by said virtual documents obtained and a step of generating said documents in an electronic format, containing the paragraphs returned by said request and the layout returned by said request for each virtual document obtained. Advantageously, several different documents are generated simultaneously and in a practical manner thanks to the static index.

According to an aspect of the invention, the static index comprises the same virtual document associated with several different generation contexts in such a way as to limit the number of virtual documents. Alternatively or cumulatively with the mutualisation of paragraphs and/or layouts, the virtual documents can also be mutualised, in such a way that the same virtual document is associated with a plurality of generation contexts. A large number of generation contexts allows a user to precisely choose the document that he wants to generate. The mutualisation of the virtual documents makes it possible to provide the user with a large selection of documents to be generated while still retaining a limited number of virtual documents. As such, a user can form a generation context that is very precise corresponding to his expectations, although said generation context is associated with a virtual document which itself is associated with other more general generation contexts. The precise desires of the user are fulfilled while still retaining a method for generating that is fast, reliable and of which maintenance is easy. In addition, via analysis of the static index, it is possible to determine the level of mutualisation of each virtual document, which facilitates the maintenance of said static index.

Similarly, the static index comprises the same pre-finalised document PDF associated with several different generation contexts. As such, a large number of generation contexts are advantageously defined which correspond to the precise expectations of the users while still limiting the number of virtual documents and of pre-finalised documents PDF. The static index makes it possible to improve mutualisation.

Thanks to such a static index, several different generation contexts point to the same virtual document, which limits the number and the variety of virtual documents and, consequently, the number and the variety of paragraphs and/or layouts. In other words, a large number of different documents can be generated with a limited number of paragraphs and/or layouts. The mutualisation of the paragraphs and of the layouts facilitates maintenance, which is further facilitated by the mutualisation of the virtual documents. In other words, the method according to the invention implements a cascade of mutualisations (paragraphs, layouts, virtual documents).

Preferably, the pre-finalised document in PDF format is a document of the form type.

The invention also relates to a system for the automatic generation of at least one document, in particular of the power of attorney type intended to authorise a proxy to perform an action on behalf of a principal, with the document containing a plurality of paragraphs displayed according to a layout, with said plurality of paragraphs and said layout being according to at least one first parameter and one second parameter, with the system for generating comprising:

a database comprising at least:

one base of layouts;

one base of paragraphs;

one base of pre-finalised documents in PDF format comprising a fixed frame, comprising predetermined paragraphs and layout, and at least one variable field;

a list of values of said first parameter;

a list of values of said second parameter, with each combination of values of said parameters forming a generation context;

a static index that associates each generation context with a virtual document or with a pre-finalised document in PDF format, with a virtual document comprising at least one pointer aiming for a determined layout of the base of layouts and a plurality of pointers aiming for determined paragraphs from the base of paragraphs; and

a module for generating able to:

consult the static index so as to obtain the virtual document or the pre-finalised document in PDF format from the base of pre-finalised documents in PDF format associated with a generation context determined beforehand;

in the case of a virtual document, making a request in the database of the layout and of the paragraphs pointed to by the virtual document obtained and generating a document in an electronic format, containing the paragraphs returned by said request and the layout returned by said request.

in the case of a pre-finalised document in PDF format, filling in the value of the variable field of said pre-finalised document in PDF format and generating a finalised document in an electronic format.

The system of the invention has the same advantages as the method of the invention.

Preferably, at least one paragraph comprising a fixed frame and at least one variable field, the module for generating is able to retrieve the value of the variable field of said paragraph in a data entry form or in another database and to associate this value with the fixed frame of said paragraph.

Preferably, the system comprises means able to generate a data entry form according to the generation context.

### BRIEF DESCRIPTION OF THE DRAWINGS

The invention shall be better understood when reading the following description, provided solely by way of example, and in reference to the annexed drawings wherein:

FIG. 1 diagrammatically shows a system for the automatic generation of documents from a database of a data server;

FIG. 2 diagrammatically shows a generated document;

FIG. 3 diagrammatically and generally shows the steps of the method for the automatic generation of documents; and

FIG. 4 diagrammatically shows said steps for implementing in relation with the elements of the database of the system for generating.

Note that the figures disclose the invention in a detailed way in order to implement the invention, said figures can of course be used to better define the invention where applicable.

### DETAILED DESCRIPTION

The invention relates, according to a first aspect, to a method for the automatic generation of a document, such as a document of the power of attorney type intended to authorise a proxy to perform an action on behalf of a principal, for example a power authorising a lawyer or an industrial property firm to represent a client before a national or regional industrial property office for the management of one several industrial property rights.

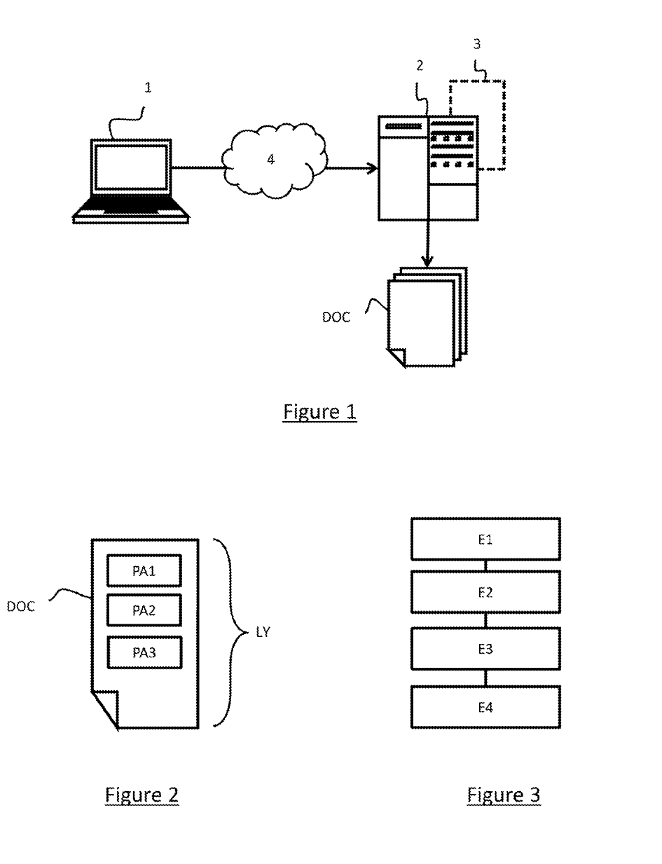

Preferably, in reference to FIG. 1, the method for generating is implemented by a system for generating comprising a data server 2 accessible by a user terminal 1 via a communication network 4, preferably, via the internet network. The data server 2 comprises a database 3 from which can be generated a plurality of documents DOC. The data server 2 further comprises a module for generating (not shown) that has the form of a computing unit, for example, a processor.

Ordinarily, the user terminal 1 is a computer system comprising a central unit, a display device such as a screen, a pointing device such as a mouse and an input device such as a keyboard.

The database 3 is stored in a computerised central unit of the data server 2 but it could be stored in a separate and/or remote storage device that can be accessed by any ad hoc means of communication. The database 3 can itself be stored on a single storage device, or in a distributed manner over several separate or remote storage devices and/or in relation to one another.

Preferably, the displaying and the retrieving of the generated document DOC are carried out on the user terminal 1 via the communication network 4. Preferably, the data server 2 implements a web interface through which the user terminal 1 can select values of parameters that define the nature of the document to be generated. The generated documents DOC can be downloaded from this web interface and can be displayed by the latter.

In reference to FIG. 2, a document to be generated DOC comprises a plurality of paragraphs PA1, PA2, PA3 which are presented according to at least one layout LY.

Recall that layout LY means all of the display characteristics that determine the position according to which, and the way in which the content of the paragraphs in a document DOC are displayed. This can therefore entail, in addition to position characteristics, characteristics for the display font, the size of the display font, display colour, underlining, framing, the presence or not of page header(s) and/or footer(s) and/or of logo(s), etc.

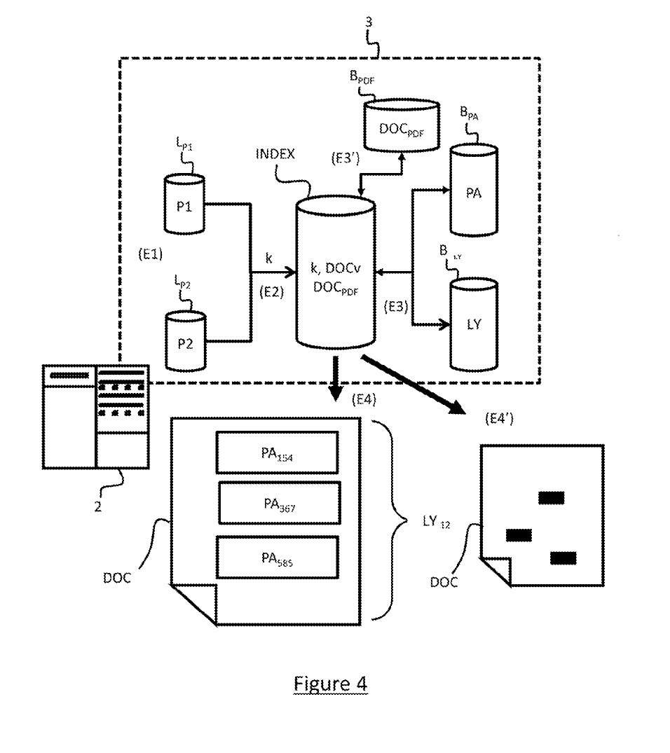

In reference to FIG. 4, the database 3 comprises a base of paragraphs BPA as well as a base of layouts B_{LY} which are, preferably, organised according to the determined criteria in order to facilitate the maintenance and updating thereof. In other words, the database 3 groups together the elements that constitute the documents to be generated DOC.

According to the invention, generating a document DOC is according to at least one first parameter P1 and one second parameter P2. In this example, in reference to FIG. 4, the database 3 comprises a list of values L_{P1} of the first parameter P1 and a list of values L_{P2} of the second parameter P2.

It goes without saying that the invention applies to the generating of a document DOC from more than two parameters as well as the generating of a plurality of documents from a plurality of parameters.

In this embodiment of the invention, each combination of values of the first parameter P1 and of the second parameter P2 forms a generation context of the document k. However, certain combinations of parameters are and form generation contexts that are erroneous which are not associated with a virtual document.

As an example, if the list of values of the first parameter P1 comprises 2 elements and if the list of values of the second parameter P2 comprises 3 elements, the potential number of combinations is equal to 6. However, if a combination of values is not possible, this combination is not taken into account and/or leads to an error message which is displayed on the terminal 1 shown in FIG. 1. Alternatively or cumulatively, the selection of the value of the second parameter P2 is conditioned by the value of the first parameter P1 selected. In other words in this case, the system of the invention and more precisely the interface for selecting the values of parameters prohibits selecting values that are incompatible with each other.

Still in reference to FIG. 4, the database 3 comprises a static index INDEX that associates each generation context k, either with a virtual document DOCv, or with a pre-finalised document in PDF format DOC_{PDF}.

The static index INDEX (and more precisely its content) is predetermined or predefined before the implementation of the method for generating. As such, it is sufficient to implement the method for generating in order to generate, from a generation context k, a document DOC generated from either the virtual document DOCv or from the pre-finalised document in PDF format DOC_{PDF} associated via the static index INDEX to the generation context k. In the hypothesis where it is desired to update or create a new document DOC to be generated according to a certain generation context k, it is sufficient to adapt the static index INDEX consequently, by setting the parameters so that it associates with said generation context k, either a virtual document DOCv, or a pre-finalised document in PDF format DOC_{PDF}, allowing for the generation of the desired document DOC.

An association of a generation context k with a virtual document DOCv will be presented in a first part, then an association of a generation context k with a pre-finalised document in PDF format DOC_{PDF} will be presented in a second part.

### First Part: Association of a Generation Context k with a Virtual Document DOCv

A virtual document DOCv is a computer object comprising at least one pointer POLY (not shown) aiming for a determined layout LY of the base of layouts B_{LY} and a plurality of pointers PO_{PA1}, PO_{PA2}, PO_{PA3} (not shown) aiming for determined paragraphs PA of the base of paragraphs B_{PA}.

In other words, a virtual document DOCv for a determined generation context k comprises a link to the layout LY that is suitable for said generation context k and links to the paragraphs PA suitable for said generation context k. As such, the static index INDEX determines the logic organisation of the elements that form a document (paragraphs and layout) in order to form a document to be generated DOC from a generation context k.

Each virtual document DOCv comprises all of the links to form the document DOC pour a determined generation context k. As each virtual document DOCv comprises all of the links (pointers) to form the document DOC for a determined generation context k, it is also possible, via analysis of the static index INDEX, to know which paragraphs PA and which layouts LY are used in which documents DOC. In other words, the analysis of the static index INDEX makes it possible to know the level of mutualisation of each paragraph PA of the base of paragraphs B_{PA} and of each layout LY of the base of layouts B_{LY}. By way of example, thanks to this analysis, an unused paragraph of the base of paragraphs BPA can be deleted, or a layout LY that is hardly used, of which the level of mutualisation is low, can be deleted and replaced with a similar layout of which the level of mutualisation is higher. A base of paragraphs B_{PA} or of layouts B_{LY} comprising a reduced number of paragraphs PA and of layouts LY is simpler to maintain and update.

In other terms, the bases of layouts B_{LY} and of paragraphs B_{PA} form reservoirs of elements for the documents to be generated DOC, the static index INDEX forming the logic links in order to organise said elements within a document DOC according to the desired generation context k. As such, the reservoirs of elements, on the one hand, and the organisation logic of said elements, on the other hand, are dissociated, which accelerates the maintenance of the database 3 while still offering great freedom in design.

Indeed, if a paragraph (and/or a layout) has to be modified for a set of documents DOC, it is only necessary to modify said paragraph in the base of paragraphs B_{PA}. This modification will affect all of the documents DOC generated from virtual documents DOCv that point to the paragraph (and/or the layout) involved, without it being necessary to update the virtual documents DOCv, since the later already point to the modified paragraph (and/or the layout). As such, and again, no modification of the virtual documents DOCv has to be implemented, given that the organisation logic of said documents DOC is not affected by the modification of a paragraph (and/or of a layout). Furthermore, as the relations between, on the one hand, the paragraphs and the layouts used and, on the other hand, the documents DOC that use them, are known (thanks to the virtual documents DOCv that establish the links between them), it is possible to easily determine if a modification of a paragraph PA and/or of a layout LY will be suitable for all of the virtual documents DOCv pointing to said paragraph PA and/or said layout LY. This facilitates maintenance of the database 3.

On the contrary, if the order, presence or absence of paragraphs PA in a document DOC for a determined generation context k1 has to be modified, it is only necessary to modify the order, presence or absence of the pointers PO_{PA} of the virtual document DOCv1 associated with said determined generation context k1. No modification of the base of paragraphs B_{PA} must be implemented given that the content of the paragraphs of said documents DOC is not affected. The same applies of course for the layouts.

According to an embodiment, a plurality of generation contexts k are associated with identical virtual documents DOCv (or even, preferably, with the same virtual document DOCv), and therefore with identical pointers. As an example, a first generation context k1 with regards to the following parameter values “filing of a patent application; Belgium; specific” and a second generation context k2 with regards to the following parameter values “filing of a patent application; Belgium; general” are associated with the same virtual document DOCv8. In other words, a generated document DOC for a general power for a patent application in Belgium is identical to a generated document DOC for a specific power for a patent application in Belgium. The user as such has the possibility of choosing a specific or a general power although the generated documents are identical, as they are associated with the same virtual document. Such a mutualisation of virtual document makes it possible to limit the number of virtual documents of the static index INDEX while still allowing the user to precisely choose the document of his choice. In addition, the size of the database 3 is limited and the mutualisation of the paragraphs PA and of the layouts LY is increased, thanks to a mutualisation of the virtual documents DOCv.

Furthermore, if in the future, a general power for a patent application in Belgium would have to be different from a specific power for a patent application in Belgium, it would be sufficient to create a new virtual document DOCv9 for the second generation context k2 in order to add a link to a paragraph PAX₁₇ that is not present in the virtual document DOCv8. Such a new virtual document DOCv9 is simple to obtain as it is sufficient to copy the virtual document DOCv8 and to add a pointer PO_{PA} to the missing paragraph PAX₁₇ of the base of paragraphs B_{PA}.

This mutualisation of the paragraphs PA and of the layouts LY makes it possible to reduce the quantity of information to be stored but also to facilitate maintenance. It facilitates for example the creation of new documents to be generated of which the content is close to other documents that exist in the database 3. It also facilitates the application of the same modification to a series of documents that exist in the database 3.

### Second Part: Association of a Generation Context k with a Pre-Finalised Document in PDF Format DOC_{PDF}

An association of a generation context k with a pre-finalised document in PDF format DOC_{PDF} shall be presented.

In some circumstances, the document to be generated DOC can comprise a fixed frame, for example imposed by a national industrial property office, and empty zones to be filled in. In other words, the format is strictly imposed and it is not possible to freely reproduce it by choosing a layout or paragraphs coming from the corresponding databases.

In order to respond to this specificity, in reference to FIG. 4, the database 3 further comprises a base B_{PDF} of pre-finalised documents in PDF format DOC_{PDF} each comprising a fixed frame—comprising predetermined paragraphs and layout—and a variable field instead of each empty zone.

According to the embodiment described, the static index INDEX associates a generation context k with a pre-finalised document PDF DOC_{PDF} indirectly, the static index INDEX comprising in this case a pointer that aims for a pre-finalised document in PDF format DOC_{PDF} contained in the base B_{PDF} of pre-finalised documents in PDF format. According to another embodiment, the static index INDEX associates a generation context k with a pre-finalised document in PDF format DOC_{PDF} directly, with the pre-finalised document PDF DOC_{PDF} being in this case stored in the static index INDEX; in other words, in this case, the base B_{PDF} of pre-finalised documents in PDF format is directly contained in the static index INDEX. In both cases, in response to the implementation of the method of the invention, the static index INDEX associates with the generation context k the pre-finalised document PDF DOC_{PDF} and makes it possible, using the latter, the generating of the document DOC, of which the layout and the paragraphs correspond to those of the pre-finalised document DOC_{PDF}.

Similarly to a virtual document DOCv, a plurality of generation contexts k can be associated with the same pre-finalised document PDF in such a way as to increase the mutualisation and limit the size of the base B_{PDF} of pre-finalised documents PDF.

In order to fill in the variable fields of the pre-finalised document PDF DOC_{PDF}, the system is able to generate a data entry form wherein is keyed in the value of the variable field or the value of the variable field is retrieved from another database.

### Implementation

Other characteristics and advantages of the invention shall appear more clearly when reading the description hereinafter of preferred alternatives and embodiments, which are provided as non-limiting examples and in reference to the annexed drawing wherein FIG. 4 diagrammatically shows, among other elements, the main elements of an example of a system according to the invention allowing for the implementation of a method according to the invention.

This invention is hereinafter shown using an example for generating documents consisting of powers intended to allow a local representative to carry out an action on behalf of a requester with a local authority or administration. This can be for example, in the field of industrial property, powers for filing a patent application or registering a mark, with the competent local authorities. This here entails the generating of a document from the association of the generation context k with a virtual document DOCv in the static index INDEX.

In the first example shown in FIG. 4, the document DOC to be generated contains three paragraphs and a layout that determines the position of the paragraphs in determined locations, their display with a certain display font, a certain size, whether or not underlined, whether or not in bold characters.

In this example, the layout and the paragraphs of the document DOC depend on a certain number of parameters, here:

a first parameter P1 consisting in the nature of the action for which the power is given, and

a second parameter P2 consisting in the local administration with which the action is to be carried out.

These parameters P1, P2 can have values grouped together in lists of values L_{P1}, L_{P2} stored in the database 3.

In the example, the list of values L_{P1} of the first parameter P1 with regards to the nature of the action comprises different possible values such as: filing, withdrawal, etc.

The list of values L_{P2} of the second parameter P2 with regards to the local administration comprises different possible values such as: the European Patent Office (EPO), the United States Patent and Trademark Office, etc.

In this example, the different possible values for the second parameter P2 can be according to the possible values of the first parameter P1. In other words, the selection can be conditional, and more precisely the values of the second parameter P2 that can be selected are conditioned to the value chosen for the first parameter P1.

As such, the value P2=“EPO” is a possible value of the second parameter P2 when the value of the first parameter P1 is “filing of a patent application”, but is not a possible value of this second parameter P2 when the value of the first parameter P1 is =“registration of a mark”. In other words, the combination (registration of a mark; EPO) is not a possible combination of parameters P1, P2. All of the possible (or viable) combinations of values of parameters form all of the generation contexts k associated with virtual documents DOCv and therefore allowing for the generation of documents DOC.

In reference to FIG. 3, the steps E1-E4 of the method for generating according to the invention shall now be presented in detail.

### Step E1 of Selecting

The method comprises a step E1 of selecting a value of the first parameter P1 and a value of the second parameter P2 so as to form a generation context k.

In this example, the generation context k is formed from the selection of the value for the first parameter P1=“filing of a patent application” and of the value for the second parameter P2=“Belgium”.

The combination (P1; P2) of the values “filing of a patent application; Belgium” forms the generation context k.

### Step E2 of Consulting

The method further comprises a step E2 of consulting the static index INDEX in order to obtain the virtual document DOCv associated with said generation context k, i.e., “filing a patent application; Belgium”.

In this example, the virtual document DOCv associated with said generation context k comprises four pointers:

three paragraph pointers PO1_{PA}, PO2_{PA}, PO3_{PA} and

one layout pointer PO_{LY}.

Pointers PO1_{PA}, PO2_{PA}, PO3_{PA}, PO_{LY} concern respectively paragraphs PA₁₅₄ PA₃₆₇, PA₅₈₅ and the layout LY₁₂. Such pointers are advantageous as they make it possible to directly determine and in a predetermined manner the elements of the document DOC to be generated for the determined generation context k. In other words, there is no conditional step that can slow down the generating of the document DOC.

### Step E3 of Requesting

The method comprises a step E3 of requesting in the database 3 elements concerned by the pointers PO1_{PA}, PO2_{PA}, PO3_{PA}, PO_{LY} of the virtual document DOCv obtained for the determined generation context k, i.e., paragraphs PA₁₅₄ PA₃₆₇, PA₅₈₅ and the layout LY₁₂.

### Step E4 of Generating

The method further comprises a step E4 of generating said document DOC in an electronic format, with the document DOC containing the paragraphs returned by said step E3 of requesting, arranged according to the layout L₁₂ also returned by the step E3 of requesting.

Thanks to this implementation, the generating of a document DOC is immediate due to the rapidity of the step E3 of requesting. This is particularly advantageous when the generation context k is formed from a large number of parameter values, with the large number of values not affecting the processing time given that the static index is predetermined. The number of documents to be generated simultaneously has little influence as such on the speed of generating the documents.

This is furthermore advantageous for forming several documents DOC from a single step E1 of selecting. As such, a single value of a first parameter can be selected, for example “filing of a patent application”, and several values of a second parameter (“Belgium”, “Spain”, “Poland”) in order to quickly form three generation contexts k and as such automatically generate three documents DOC.

### Paragraph with Variable Field

In an alternative embodiment, at least one paragraph PA comprises a fixed portion, designated as “fixed frame”, and at least one variable portion, designated as “variable field”.

As such, for example, only the fixed frame of a paragraph PA is stored in the database, with the value of the variable field able to be keyed in directly by the user or obtained via a request in another database.

The step of generating the document then comprises a step of key-entry into a data entry form, or a step of retrieving in another database, of a value of the variable field, and a step of inserting this value into the paragraph PA with the fixed frame of the paragraph.

By way of example, the paragraph comprises a fixed frame that indicates the actions to be carried out on a European patent right of which the filing number is not filled in. In other words, the filing number forms a variable field.

During the step of generating the document, the fixed frame of the paragraph that is pointed to is filled in with the filing number keyed in directly by the user or retrieved in another database. In this latter hypothesis, and for example, the filing number can be retrieved in another database comprising the list of patent rights of the user.

In this embodiment, a paragraph PA was presented comprising a single variable field. It goes without saying that a paragraph PA could comprises several of them, for example, a filing number, a filing date, the name of an agent, etc.

According to a particular embodiment, the value of a variable field is chosen from a series of possible values presented to the user, for example in the form of a drop-down list of values wherein the user can choose one or several values for the variable field.

According to a particular embodiment, the method comprises a step of generating a data entry form which is according to the generation context. This provides the method with great flexibility which makes it possible, according to the generation context, to provide or not provide the user with a form depending on this context.

For example, in order to generate a power to transfer a patent application, a user selects the parameter values so as to determine the generation context of a transfer of a patent right. The virtual document associated with the determined generation context comprises pointers that concern the paragraphs PA which comprise variable fields. So, the system for generating generates the display of a data entry form which comprises the variable fields to be filled in for all of the paragraphs PA pointed to; these variable fields can for example allow for the introduction of information on the transfer concerned by the power.

It is sufficient for the user to fill in all of the variable fields in order to allow for the generating of the desired power. Such a method makes it possible to customise a paragraph according to the generation context, which is advantageous and improves the quality and the precision of the generated documents. Such a method is particularly advantageous for simultaneously generating a large number of documents wherein the same variable field is inserted.

In a second example shown in FIG. 4, the document DOC to be generated must be carried out from a paper form provided by an industrial property office and which contains empty zones.

In order to obtain the base of pre-finalised documents B_{PDF}, the paper forms of industrial property offices are scanned then the variable fields are added by computer in place of said empty zones.

In a manner similar to hereinabove, the user selects the parameters to form a generation context k (step 1) in such a way that the system consults the static index INDEX (step 2). In this second embodiment, the generation context k is associated with a pre-finalised document DOC_{PDF} indirectly, the static index INDEX comprising a pointer aiming for a pre-finalised document DOC_{PDF} of the base of pre-finalised documents B_{PDF}.

The method comprises a step E3′ for requesting in the base B_{PDF} pre-finalised documents DOC_{PDF} in order to obtain the pre-finalised document DOC_{PDF} associated with the generation context k.

The method then comprises a step of filling in values of variable fields of the pre-finalised document DOC_{PDF}, in particular, the number of the intellectual property right, etc. This step of filling in can be carried out by key-entry into a data entry form or by retrieving in another database as indicated hereinabove. The method then comprises a step of generating a finalised document (E4).

With the method for generating a document having been presented, the invention also relates to a system for generating for the implementing of said method.

The invention relates, according to a second aspect, to a system for the automatic generation of at least one document, in particular a data server 2, comprising a database 3 such as presented hereinabove and a module for generating able to:

consult the static index INDEX so as to obtain the virtual document DOCv from a generation context k determined beforehand;

in the case of a virtual document, make a request in the database 3 of the layout LY and of the paragraphs PA pointed to by the virtual document obtained DOCv; and generate a document DOC in an electronic format, containing the paragraphs PA returned by said request and the layout LY returned by said request;

in the case of a pre-finalised document in PDF format, filling in the value of the variable field of said pre-finalised document in PDF format DOC_{PDF} and generating a finalised document in an electronic format.

Advantageously, the system for generating benefits from the same advantages as those linked to the method for generating presented hereinabove.

Advantageously, thanks to the system according to the invention, the content and the values as such of the elements of the document to be generated (layouts, paragraphs) are dissociated from the association logic of said elements (virtual document). Such a dissociation makes it possible to offer great flexibility for generating documents thanks to the module for generating.

Furthermore, the implementing of a request by the module for generating is fast given that each generation context is associated with a virtual document that comprises the definition of all of the elements of the document (layout and paragraphs). In other words, thanks to the static index, the content of a document to be generated is directly determined from the generation context. Such a system for generating limits the waiting time of a user who obtains the desired document instantly, since the processing time of the system is as such minimised.

Such a system is particularly advantageous for generating a large number of documents simultaneously, in particular, powers for a plurality of jurisdictions.

Also, the invention is not limited to a determined computer architecture, such as the one shown in FIG. 4. The database 3 as well as the module for generating can be implemented in a distributed manner or not, on the same unit or not. Furthermore, the generating of the document DOC can also take place in the server 2 whereon is implemented the module for generating or at the level of a remote unit connected to the server 2 by the intermediary of a communications network, or both.

All of the description hereinabove is given by way of example and does not limit the invention.

In particular, the invention is not limited to the generating of powers, a fortiori to the generating of powers in the field of industrial property.

Moreover, information other than the content of the paragraphs and their layout could be determined by the parameter or parameters. Thought may be given for example to whether or not a power exists, to the paper to be used to print it, etc.

1. Method for the automatic generation of at least one document, in particular of the power of attorney type intended to authorise a proxy to perform an action on behalf of a principal, with the document containing a plurality of paragraphs displayed according to a layout, with said plurality of paragraphs and said layout being according to at least one first parameter and a second parameter, with the method implementing a database comprising at least:
one base of layouts;
one base of paragraphs;
one base of pre-finalised documents in PDF format comprising a fixed frame, comprising predetermined paragraphs and layout, and at least one variable field;
a list of values of said first parameter;
a list of values of said second parameter, with each combination of values of said parameters forming a generation context;
a static index that associates each generation context with a virtual document or with a pre-finalised document in PDF format of the base of pre-finalised documents in PDF format, with a virtual document comprising at least one pointer aiming for a determined layout of the base of layouts and a plurality of pointers concerning determined paragraphs of the base of paragraphs; method characterised in that it comprises:
a step for selecting values of the first parameter and of the second parameter so as to form a generation context;
a step for consulting the static index so as to obtain the virtual document or the pre-finalised document in PDF format associated with said generation context;
in the case of a virtual document, a step for making a request in the database for layout and paragraphs pointed to by the virtual document obtained and a step for generating said document in an electronic format, containing the paragraphs returned by said request and the layout returned by said request,
in the case of a pre-finalised document in PDF format, a step of key-entry into a data entry form, or a step of retrieving in another database, of the value of the variable field of said pre-finalised document in PDF format and a step of generating said finalised document in an electronic format.

2. Method according to claim 1, with the document comprising at least one paragraph comprising a fixed frame and at least one variable field.

3. Method according to claim 2, wherein, the method comprises a step of key-entry into a data entry form, or a step of retrieving in another database, of the value of the variable field of said paragraph.

4. Method according to claim 3, comprising a step of generating a data entry form according to the generation context and a step of key-entry into the data entry form of the value of the variable field of said paragraph.

5. Method according to claim 1, wherein the step of selecting at least one parameter is done conditionally according to the value of at least one other parameter.

6. Method according to claim 1, wherein several values of the same parameter are selected during the step of selecting in such a way as to form several generation contexts and as such generate several documents.

7. Method according to claim 6, comprising:
a step for consulting the static index so as to obtain the virtual documents or the pre-finalised documents associated with said generation contexts; and
a step of generating said documents.

8. Method according to claim 1, wherein the static index comprises the same virtual document associated with several different generation contexts.

9. System for the automatic generation of at least one document, in particular of the power of attorney type intended to authorise a proxy to perform an action on behalf of a principal, with the document containing a plurality of paragraphs displayed according to a layout, with said plurality of paragraphs and said layout being according to at least one first parameter and one second parameter, with the system for generating comprising:
a database comprising at least:
one base of layouts;
one base of paragraphs;
one base of pre-finalised documents in PDF format comprising a fixed frame, comprising predetermined paragraphs and layout, and at least one variable field;
a list of values of said first parameter;
a list of values of said second parameter, with each combination of values of said parameters forming a generation context;
a static index that associates each generation context with a virtual document or with a pre-finalised document in PDF format of the base of pre-finalised documents in PDF format, a virtual document comprising at least one pointer aiming for a determined layout of the base of layouts and a plurality of pointers concerning determined paragraphs of the base of paragraphs; and
a module for generating able to:
consult the static index so as to obtain the virtual document or the pre-finalised document in PDF format associated with a generation context determined beforehand;
in the case of a virtual document, making a request in the database of the layout and of the paragraphs pointed to by the virtual document obtained; and generating a document in an electronic format, containing the paragraphs returned by said request and the layout returned by said request.
in the case of a pre-finalised document in PDF format, filling in the value of the variable field of said pre-finalised document in PDF format and generating a finalised document in an electronic format.

10. System according to claim 9, at least one paragraph comprising a fixed frame and at least one variable field, the module for generating is able to retrieve the value of the variable field of said paragraph in a data entry form or in another database and to associate this value with the fixed frame of said paragraph.

11. System according to claim 10 comprising means able to generate a data entry form according to the generation context.
